(19) United States
(12) Patent Application Publication
(10) Pub. No.: US 2026/0313003 A1
(43) Pub. Date: Oct. 8, 2026

(54) Systems and methods for categorizing policy rules for enforcement

(71) Applicant: Sophos Limited, Abingdon (GB)

(72) Inventors: Manpreet Kaur Gosal, Burnaby (CA); Christopher Adam Telfer, Port Matilda, PA (US)

(21) Appl. No.: 19/169,995

(22) Filed: Apr. 3, 2025

(51) Int. Cl. H04L 9/40

(52) U.S. Cl. CPC H04L 63/205

(57) ABSTRACT

Systems and methods for generating a network policy. The method includes receiving at an interface a plurality of ranked goal-based rules to be enforced on at least one enforcement point of a network; determining, using a policy engine, at least one of an access component or a control component of each of the plurality of ranked goal-based rules, wherein the access component indicates whether to allow or prevent network traffic and the control component indicates a control option regarding network traffic for the enforcement point; determining whether a match criteria associated with each of the plurality of goal-based rules is satisfied by a policy input object; generating, using the policy engine, an output policy object that includes at least one of an access component of a highest ranked goal-based rule with satisfied match criteria or a control component of a highest ranked goal-based rule with satisfied match criteria; and providing the output policy object to the enforcement point for enforcement.

### TECHNICAL FIELD

The present application relates generally to systems and methods for monitoring network activity and, more particularly but not exclusively, to systems and methods for generating a network policy.

### BACKGROUND

Secure Access Service Edge (SASE) is a cloud computing service to provide security controls at network endpoints or otherwise at edge computing locations. An administrator may use SASE to enforce a particular security policy on their network. This may require the administrator to create multiple rules for each individual device, network, subnet, or the like.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments herein provide systems and methods for generating a network policy. A network administrator or other interested personnel may provide a tenant policy including a plurality of goal-based rules to be enforced on each of a plurality of enforcement points of a network. A policy engine may receive a rules object and at least one common object that are each associated with the policy. The policy engine may analyze a input policy object against the rules object and the at least one common object to determine whether a match criteria is satisfied, and then provide an enforcement decision to the enforcement point regarding enforcement of the policy.

In some embodiments, the policy engine may determine at least one of an access component associated with each of the plurality of goal-based rule or a control component associated with each of the plurality of goal-based rules. The policy engine may determine whether a match criteria associated with each of the plurality of goal-based rules is satisfied by a input policy object, and generate an output policy object that includes at least one of an access component of a highest ranked goal-based rule with satisfied match criteria or a control component of a highest ranked goal-based rule with satisfied match criteria. The policy engine may then provide the output policy object to the enforcement point for enforcement.

In some embodiments, the policy engine may transform the policy into a first sub-ruleset that receives as input a first portion of the plurality of attributes at a first stage of a connection, and a second sub-ruleset that receives as input a second portion of the plurality of attributes at a second stage of the connection. The policy engine may then process at least the first portion of the plurality of attributes at the first stage to determine whether to enforce the goal-based rule at the enforcement point.

### BRIEF DESCRIPTION OF DRAWINGS

Non-limiting and non-exhaustive embodiments of the disclosed subject matter are described with reference to the following figures, wherein like reference numerals refer to like parts throughout the various views unless otherwise specified:

FIG. 1 illustrates a block diagram of a threat management system in accordance with one embodiment;

FIG. 2 illustrates a system for generating a network policy in accordance with one embodiment;

FIG. 3 illustrates a plurality of policy decision points in accordance with one embodiment;

FIG. 4 illustrates an enforcement point and a policy engine in accordance with one embodiment; and

FIG. 5 presents a table of mappings of various goal-based rules in accordance with one embodiment;

FIG. 6 presents a table of ranked goal-based rules and their associated policy decision points in accordance with one embodiment; and

FIG. 7 illustrates a policy decision point performing a rule splitting procedure in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

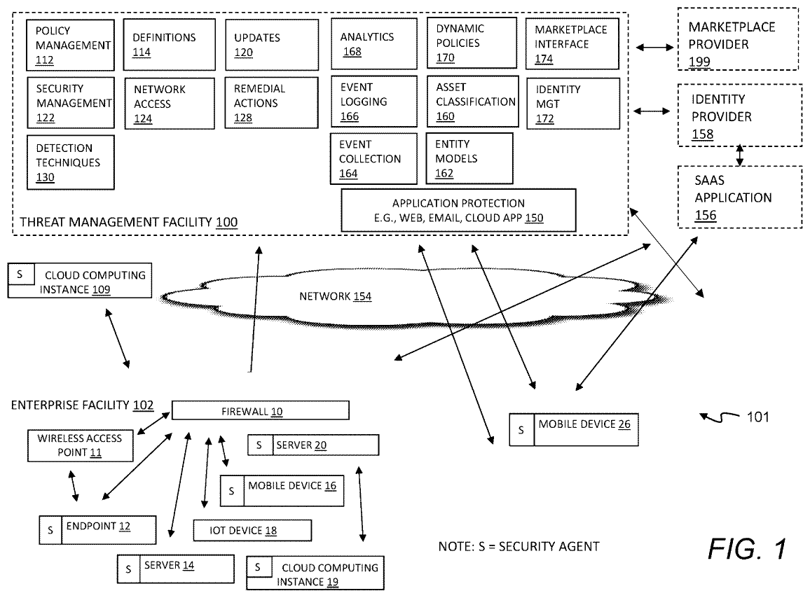

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IOT) device 18, a cloud computing instance 19, a server 20, a user device, an application load balancer 30, and a network load balancer 34. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include or otherwise be in communication certain facilities, such as a policy management facility 112, security management facility 122, update facility 120, definitions facility 114, network access facility 124, remedial action facility 128, detection techniques facility 130, a Secure Access Service Edge (SASE) architecture 132, a cloud controller 134, application protection 150, asset classification facility 160, entity model facility 162, event collection facility 164, event logging facility 166, analytics facility 168, dynamic policies facility 170, identity management facility 172, and marketplace interface facility 174, a firmware repository 176, a build system 178, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an network 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102.

Network policies include one or more goal-based rules to be enforced at multiple enforcement points (also referred to as “filtering stages”). Each of these enforcement points may be associated with a policy decision point type that analyzes some aspect of the goal-based rules of the policy. In the context of the present application, “goal-based rule” may refer to single input of a text string. The text string may represent a desired action or outcome such as, but not limited to, “block website,” “allow website,” “enforce safe search,” “scan for threats,” “do not decrypt,” “block file types,” “don't scan,” “block non-web traffic,” “allow non-web traffic,” “block application traffic,” “apply a DNS filter,” “implement a firewall rule,” “implement a web access rule,” “implement a decryption rule,” “implement a web content filter rule,” or “implement an application control rule.”

Enforcement points may refer to stages of a network connection, such as the Domain Name Server (DNS), firewall, Transport Layer Security (“TLS”), etc. There may also be different types of goal-based rules. For example, the web gateway rule type may refer to a security solution that an organization can use to help monitor network activity, protect the organization from threats, or some combination thereof. Examples of web gateway goal-based rules may include rules to block a website from being accessed (“block website”), allow a website to be accessed (“allow website”), enforce a “safe search” feature (“enforce safe search”), scan traffic for threats (“scan for threats”), to not decrypt data (“never decrypt”), block certain file types from being transmitted or received (“block file types”), not scan traffic (“don't scan”), etc.

There may be various parameters or conditions associated with each of these rules. The “block website” rule may have conditions such as the user(s) to whom the rule is applicable and the actual website to be blocked. The user(s) may be identified by a username or other type of unique identifier, employee group, object, or the like. The website may be identified by URL, type of website, or the like. For this rule, DNS and web access are the applicable enforcement points.

A firewall enforcement point may be associated with several different types of goal-based rules. These goal-based rules may include rules to block non-web traffic (“block non-web traffic”); allow non-web traffic (“allow non-web traffic”); a rule to allow traffic, decrypt the traffic, and inspect the traffic (“allow, decrypt, and inspect”), block application traffic from being transmitted (“block application traffic”), etc.

The firewall rule to “block non-web traffic” may have conditions such as a particular user(s) to whom the rule is applicable, to what the user is attempting to connect, the applicable port and service used for the connection, or the like. The user(s) may be identified a username, group name, device name, or the like. For this rule, firewall would be the enforcement point.

The firewall rule “allow non-web traffic” may have conditions such as the user to whom the rule applies, the destination of an attempted connection, the applicable service and port used for the connection, or the like. An additional condition may also include the inspection profile, and the strictness of the inspection of the non-web traffic. The enforcement points for this rule include intrusion prevention system (“IPS”) and firewall.

Accordingly, in addition to defining a policy with these goal-based rules, an administrator may specify relevant match criteria for each goal-based rule. One or more policy decision point types may determine whether the match criteria is satisfied, and provide policy enforcement decisions for the applicable enforcement point(s).

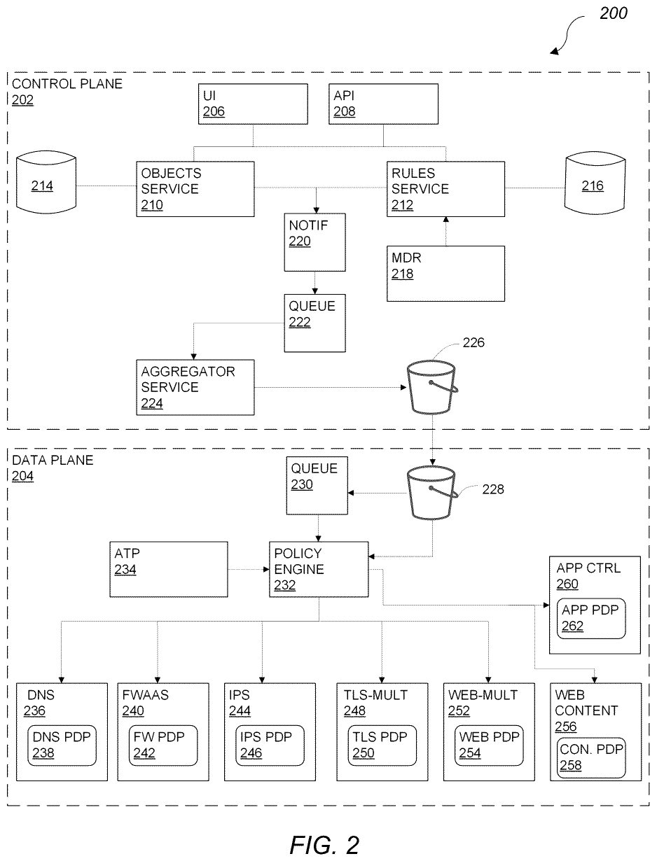

FIG. 2 illustrates a system 200 for generating a network in policy in accordance with one embodiment. The system 200 may execute on a control plane 202 that may be associated with a particular region and is in communication with a data plane 204. The control plane 202 and the data plane 204 may be part of the SASE architecture 132 of FIG. 1, for example.

In operation a user may access a user interface (“UI”) 206 or an external application programming interface (API) 208. For example, a user may be an enterprise network administrator tasked with generating one or more network policies. The administrator may be interested in creating a tenant policy including a plurality of goal-based rules to be enforced by the applicable enforcement points and without configuring each enforcement point individually.

The UI 206 or the external API 208 may communicate data such as instructions regarding one or more rules or policies. The UI 206 or the API 208 may forward data regarding common objects to an objects service 210, and data regarding tenant policy rules to a rules service 212. The objects service 210 may store the common objects in a data storage 214.

In the context of the present application, a “common object” may refer to a set of similar types of data or configurations that can be named, stored, and referenced in policy rules. Defining common objects allows an administrator to group data in a logical manner, and removes the need to define duplicate configurations across multiple network policies. The common objects are serialized into the policy objects required for evaluation in the data plane 204.

One type of common object may be a collection of internet protocol (“IP”) addresses or ranges of IP addresses. For example, an administrator of an enterprise network with multiple physical locations may use distinct sets of IP subnets at each location. The administrator can create common objects for each physical location, wherein the common objects contain the set of IP addresses or subnets that are relevant to a particular location.

The rules service 212 may store data regarding tenant policy goal-based rules in a rules storage 216. Tenant policy rules may be represented as a ruleset objects. The rules service 212 may be in further communication with a Managed Detection and Response (MDR) service 218. The MDR service 218 may create rules to, for example, block traffic based on match criteria such as IP addresses and domains.

Accordingly, an administrator may define goal-based rules to be enforced by one or more enforcement points, and may create common objects that are evaluated by policy decision points to provide enforcement decisions for the enforcement points. Embodiments herein enforce policy by evaluating an input against the tenant policy ruleset object and the common objects.

An administrator may also assign a priority ranking to each rule. Rankings may determine which rule(s) take priority if two or more rules conflict with each other. In some embodiments, the rankings may be automatically assigned to a rule or, similarly, rules may have default rankings.

An administrator may also configure various options for each rule, such as additional actions that are taken when a rule is enforced. These actions may relate to logging activity, issuing an alert to an administrator (e.g., that a user attempted to access a website and was blocked from accessing the website), presenting a message to a user regarding why a website was blocked, etc.

Instructions or updates from the objects service 210 and the rules service 212 may be first sent to a notification service 220 and then to a queue service 222 before reaching an aggregator service 224. In some embodiments, a synchronization service (not shown in FIG. 2) may also communicate notifications to the notification service 220 and queue service 222 before the communications reach the aggregator service 224. The synchronization service may provide updates regarding tenants associated with the system 200 and to create default rules therefor. For example, in some embodiments, the synchronization service may provide updates regarding new tenants that are onboarded on the system 200.

The aggregator service 224 may create policy bundles of tenant policy data (e.g., common objects and ruleset objects) that will be used for evaluating input policy objects and store these bundles in a storage 226. The aggregator service 224 may compile these policy bundles based on serialized rules obtained from the rules service 212 and based on common objects obtained from the object service 210. Accordingly, the bundled policy data may include tenant-specific policy data objects comprising tenant-specific ruleset objects and tenant-specific common objects.

The aggregator service 218 may use a schema that specifies how to configure the policy objects. Specifically, the schema defines the format and JavaScript Object Notation (“JSON”) paths to tenant-specific policy data for subsequent access in the data plane 204. Tenant policy data may be created or modified using the JSON paths in this policy bundle schema. The schema may also define the format and JSON paths to access data objects in an Open Policy Agent (“OPA”) document, discussed in greater detail in conjunction with FIG. 4.

Schemas may specify, for example, a policy rule set API, supported rule match criteria operators, and the format of policy objects that are used in match operations. Schemas may also specify inputs for fields (e.g., whether a field a regular expression (regex) field, whether a field is an enumeration value, etc.), and provide machine-readable datasets for creating objects.

The storage 226 may refer to cloud storage devices such the AMAZON S3® storage devices by Amazon. com, Inc., headquartered in Seattle, Washington. The stored bundles may be copied and stored to one or more storages 228 on the data plane 202. For example, in embodiments in which the object storages 226 and 228 are AMAZON S3® storage devices, the embodiments herein may use Cross-Region Replication (CRR) to replicate the bundles in storage 226 to the storage 228 on the data plane 204. The bundles may be communicated to the policy engine 232 or first stored in a queue service 230.

The policy engine 232 may also be in connectivity with an advanced threat protection (ATP) service 234, which may be a Security Service Edge (SSE) service that defines global policy data. In some embodiments, the ATP service 234 may create default rules, such as rules associated with high levels of security (e.g., by treating all network destinations as high-risk destinations).

The ATP service 234 may consider data from one of several sources. For example, the ATP service 234 may generate rules based on IP addresses, domains, such as those defined by their URL or path, and security category. In some embodiments, the ATP service 234 may be configured on or as part of the data plane 204. In some embodiments, the functionality provided by the MDR service 218 and the ATP service 234 may be provided by a single service located on the control plane 202.

The policy engine 232 may be tasked with communicating the rules associated to the applicable enforcement points for enforcement. Each of these enforcement points may be associated with a policy decision point (“PDP”) policy engine to determine whether match criteria associated with an applicable stage of a connection is satisfied by a input policy object.

For example, the policy engine 232 may be in communication with a domain name service (“DNS”) 236 enforcement point executing a DNS policy decision point (“PDP”) 238, a firewall-as-a-service (“FWAAS”) 240 enforcement point executing a firewall policy decision point 242, an intrusion prevention system (“IPS”) enforcement point 244 executing an IPS PDP 246, a transport layer security (“TLS”) enforcement point 248 executing a TLS PDP 250, a web enforcement point 252 executing a web PDP 254, a web content enforcement point 256 executing a content PDP 258, and an application control (“App Ctrl”) enforcement point 260 executing an APP PDP 262. Each of these enforcement points may refer to a stage of a network connection. Each enforcement point may use a decision point library, which provides an application programming interface (API) for policy data management and policy decisions.

In some embodiments, multi-policy bundles may be required for multiple enforcement points, such as if there are multiple policy evaluations required at a particular phase of a connection. For example, during the TLS handshake of a connection, the TLS enforcement point 248 may require output from the TLS PDP 250, web content PDP 258, and the APP PDP 262. For this particular case, a policy bundle may include a ruleset filtered for the TLS policy, a ruleset filtered for the web policy, a ruleset filtered for the App-ctrl policy, and the tenant's common objects may be filtered to only objects that are referenced in the above rulesets.

As discussed previously, each tenant onboarded with the system 200 may have their own tenant policy rulesets. Each of the above enforcement points can store multiple policies associated with a tenant. For each connection, an enforcement point may access or otherwise reference the applicable tenant policy for evaluating the connection and associated rules. Each policy may comprise one or more ranked rules, and each rule contains a set of match criteria that must be true for a rule to be considered “matched” and the rule to be applied or otherwise enforced by the enforcement point (assuming there are no conflicting, matched higher ranked rules).

The policy data required for a match operation may be embedded directly in a policy match operand field. All policy object data that is not created as separately-named objects may be specified as values or strings in the policy ruleset object. For example, these may include user identifiers or device identifiers and names to match, high-risk destination security score thresholds, or the like. Policy data required for a rule match operation may be specified as a JSON path to the tenant's common object data, specified as a JSON path to global policy data, or both.

Each of the enforcement points above may be associated with a policy that is analyzed by the associated PDP policy engine. For each tenant, there may be a DNS policy, firewall policy, IPS policy, TLS policy, Web URL policy, web content policy, and an App control policy. An enforcement point enforces a tenant policy using the associated PDP, which contains the applicable policy bundle for the enforcement point.

Some of the enforcement points listed above and shown in FIG. 2 may only need to evaluate one set of policy data. For example, the DNS enforcement point 236 may execute the DNS PDP 238 to analyze an associated DNS policy. A DNS policy may consider policy input data such as whether a rule applies to a particular object of a network connection.

The firewall enforcement point 240 may execute the FW PDP 242 to analyze an associated firewall policy. A firewall policy may consider policy input data such as whether a rule applies to a particular object of a network connection, as well as global policy data.

The web content enforcement point 256 may execute the content PDP 258 to analyze an associated web content policy. A web content policy may consider policy input data such as whether a rule applies to a particular object of a network connection.

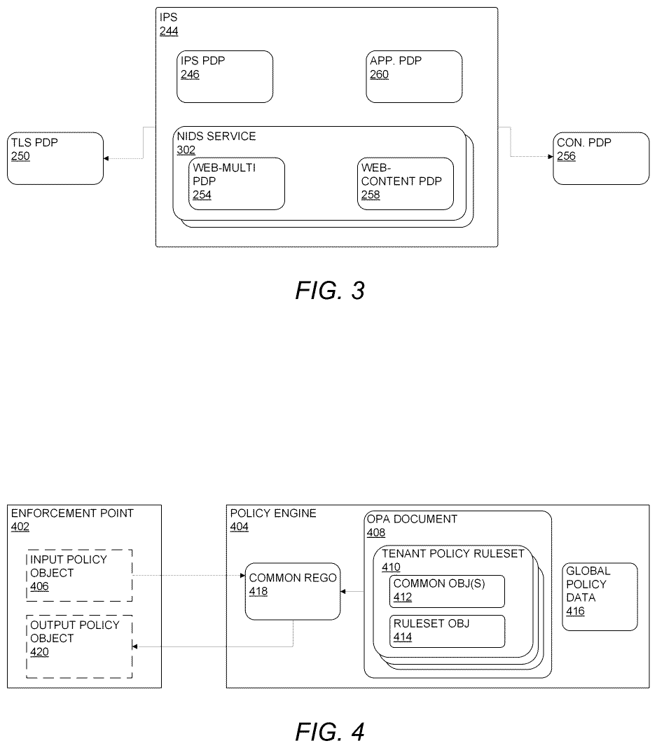

Some enforcement points, on the other hand, may be associated with more than one policy decision point types. For example, FIG. 3 illustrates the IPS enforcement point 244 executing multiple PDPs in accordance with one embodiment. The IPS enforcement point 244 may execute the IPS PDP 246 and the APP PDP 262. An IPS-based policy may be executed in response to events triggered by a network intrusion detection system (NIDS) service 302 such as SNORT®, made available by Cisco Systems, Inc., headquartered in San Jose, California. For example, the NIDS service 302 may flag a network activity signature match. As seen in FIG. 3, the NIDS service 302 drives the web-multi policies and the web content policy, as well as the TLS policy.

As seen in FIG. 3, the components of the IPS enforcement point 244 may be in communication with one or more other PDPs. For example, the TLS PDP 250 may evaluate a TLS handshake of a connection separately from the IPS enforcement point 244. Similarly, the content PDP 258 may evaluate a policy after malware scan separately from the IPS PDP 246. The TLS PDP 250 and the content PDP 258 may execute as connected services to provide supplemental functionality to the IPS enforcement point 244 for evaluating a connection.

Accordingly, in some embodiments, one or more enforcement points may require multi-policy bundles for situations in which a particular phase of a connection requires multiple policy evaluations. For example, during a TLS handshake, there may be evaluations of a TLS policy, App-ctrl policy, and web policy. These may be evaluated in a TLS policy connected service as illustrated in FIG. 3.

These multi-policy bundles may combine the policy rulesets for each type of policy. As discussed previously, these bundles also include the common objects that are referenced from each of the rulesets to form a per-tenant policy ruleset.

The enforcement points make policy decisions based on tenant policy rulesets and data that is relevant to its associated PDP types. A PDP may comprise a policy engine that may execute a common declarative query language such as the Rego query language. A PDP may integrate and use a common Rego policy in an OPA Web Assembly (“WASM”) format. The common Rego WASM binary enables supporting all PDP types. Although the present application is largely discussed in the context of using Rego, the embodiments herein may be implemented using any suitable declarative language, whether available now or invented hereafter.

The common Rego may analyze policies associated with multiple PDPs against the same input policy object. The schemas discussed above in conjunction with the aggregator service 224 specify how to combine policy rulesets and common objects for multiple types of decision points and load them into one or more OPA documents. This enables enforcement points to provide a single input policy object for policy queries, and to receive all policy results in a single output policy object returned from the policy engine.

The goal of the policy engine is to evaluate policy rules for PDPs, and to determine how to enforce a policy. Specifically, the policy engine may evaluate a input policy object provided by the enforcement point against tenant policy rulesets (which comprise the common objects and ruleset object associated with the tenant) to determine whether match criteria is satisfied and therefore whether the enforcement point should enforce a policy.

FIG. 4 illustrates an enforcement point 402 in communication with a policy engine 404 in accordance with one embodiment. The policy engine 404 may be embedded with the PDP associated with the enforcement point 402, and provide support for API specifications for all required JSON policy data, input objects, and output objects.

In operation, the enforcement point 402 may provide to the policy engine 404 a input policy object 406 including data associated with a connection for evaluation. The input policy object 406 may include various key fields. A “tenant” key may be described as a unique user identifier (“UUID”) for the tenant, and is required for every policy so that the policy engine 404 can access the appropriate tenant policy. An “http” key may refer to an object that contains HTTP protocol properties, such as the scheme or whether a request satisfies some criteria. A “user” key may refer to an object containing a user ID and a group membership list. The user ID may be a string value, where was the group membership list may be defined by a set of string values.

The policy engine 404 may use the Rego query language for analyzing document models of objects. Specifically, the policy engine 404 may have previously received from the control plane 202 the tenant policy rulesets 410, which comprise the common objects 412 and a ruleset object 414 for each tenant. The policy engine 404 may further consider global policy data objects 416, which may be referenced by a unique identifier or name. In some embodiments, however, a policy may not require the analysis of any common objects. For example, a policy may contain only match criteria that match against input fields and literal values.

These policy data objects are sorted based on the PDP(s) to which they are applicable, and then bundled together for distribution in the data plane 202 to the PDPs as discussed in conjunction with FIG. 2. The bundles contain the policy objects per each PDP type and for all supported tenants. The PDPs load the applicable policy objects from these bundles in the OPA document 408 so that the policy engine 404 can form policy decisions in response to queries by the enforcement point 402.

As seen in FIG. 4, the OPA document 408 may comprise the tenant policy rulesets 410, which include the common objects 412 and a ruleset object 414 for each tenant. Each tenant's common objects 412 and ruleset object 414 are stored separately in policy engine memory with non-overlapping JSON paths in the OPA document 408.

This configuration provides a reusable software component implementation for PDPs such that PDPs can support policy requirements for enforcement points and without implementing custom policy decision logic. The policy engine 404 may be configured for processing the OPA documentation 408, which supports multiple integration options so that each enforcement point 402 may integrate the policy engine 404 as required to meet each enforcement point's unique latency and scalability requirements.

The policy engine 404 defines the tenant policy rulesets 410 required by any particular PDP type to support policy evaluations for a particular tenant. The policy engine 404 defines the APIs for the policy objects such that they can reference other policy objects by JSON paths.

The paths may allow policy objects in the OPA document 408 to be updated from instructions from the control plane 202 of FIG. 2. Adding or updating tenant policy rulesets 410 requires services of the control plane 202 to provide updated policy objects to the data plane PDPs. The PDPs can then load new or updated policy data objects into the OPA document 408.

With this design, as long as the policy engine 404 loads policy data objects at the correct root path, the policy engine 404 can interpret policy rules and process queries with no customization or changes to the policy engine 404. This is true regardless of the PDP type.

The tenant policy rulesets 410 may be referenced in the input policy object 406 by a tenant UUID value. The policy engine 404 may use the tenant UUID, along with hardcoded paths to determine where the appropriate policy objects are stored in memory.

The policy engine 404 can continuously evaluate policy with new ruleset objects and new common objects that are loaded into data memory. The policy engine 404 may only need to be updated if a new policy match operation is required by a PDP type. If so, additional match operations can be added to a common Rego 418 in a backwards-compatible manner as policy objects are not inherently referenced in the Rego but are referenced in the tenant policy rulesets 410.

For evaluating policy, the common Rego 418 may interpret all potential policy operations that may be contained in a tenant policy ruleset 410. The input policy object 406 of tells the policy engine 404 which policy tenant data ruleset 410 to evaluate. Accordingly, the tenant policy ruleset 410 may be referenced from the OPA document 408 by JSON path.

Each goal-based rule may comprise a set of match criteria that must all be true for a given goal-based rule to be considered matched. Each match criteria has a match operation and one or two match operands. Match operations within a goal-based rule are written in the control plane 202 and define supported match operations and types of operands. A match operation determines whether the operand or operands satisfy some condition. These may include simple match operations, such as those that test an attribute of an input policy object for equality. A match operation may be more complex, such as one that tests whether any member of a first set is a member of a second set. A match operand may be a literal value, a field taken from a PDP's input, or a policy object. These operands may be embedded in a policy object or JSON paths that reference policy objects that are loaded in the OPA document 408.

The policy engine 404 evaluates a policy against the input policy object (e.g., metadata about a packet, request, response, etc.), and the set of policy objects that are provided from the control plane 202. If the match criteria is satisfied (i.e., the match operation result is true), the match operation is successful and it is considered along with other match operations defined for that goal-based rule to determine whether the policy should be enforced.

When all goal-based rules of a tenant policy are evaluated, the highest ranked rule is considered the overall policy decision and designated in the fields of an output policy object 420 provided to the enforcement point 402. The output policy object 420 may only contain an “action” field to indicate what action the enforcement point should take based on the highest ranked matching rule. Alternatively, the output policy object 420, may contain additional fields that provide other metadata related to the policy decision, such as whether to log the policy decision, display a policy block page to a connection participant (e.g., an employee attempting to access a blocked webpage).

The goal-based rules of a policy may include access components that provide an access decision result, control components that provide a control decision result, or some combination thereof. The output policy object 420 may include these access decision results and control rule results based on these respective types of rules, and these results impact if or how an enforcement point enforces a policy.

Access decision rules may refer to rules that contain some type of action for allowing or preventing traffic at some phase of a connection. Access decision results may include a policy action instruction (e.g., such as whether to allow traffic, block traffic, drop a connection, etc.), a matched rule identifier, and additional metadata that may be required for logging requirements. The rules service 212 of FIG. 2 may configure the access decision based on the type of goal-based rule. For example, the goal-based rule “block file types” is given the access decision of “block.” The output policy object 420 may include the access decision, as well as any metadata from the highest priority, matching rule.

Control rule results may refer to subsequent actions associated with a connection based on a control rule. A control rule may refer to a rule that contains a configurable policy control for an enforcement point. Some goal-based rules may, in addition to or in lieu of providing an access decision, provide policy control data to an enforcement point. These rules do not have a defined access decision value, such as to “always allow” or “always block,” but instead specify some control action or traffic steering instruction for the enforcement point.

There may be different subtypes or categories of control rules. These may include, for example, a rule to implement safe search control, perform a content scan, website tenant control rules, IPS control rules, TLS decryption rules, etc. Each of these control rules may be associated with a control rule object that includes any data that is part of the policy rule and would need to be provided to an enforcement point in the output policy object 420.

The control rule results may indicate, for example, whether traffic is scanned for malware, whether a safe search control is implemented, whether traffic is decrypted, or the like. The control rule results may also specify a matched rule ID and additional metadata fields that may control the subsequent actions the enforcement point will take.

Categorizing rules as access rules, control rules, or both allows the embodiments herein to select the highest priority, matching goal-based rule from each category. Additionally, this allows the embodiments herein to compare the priority rankings of each of these rules relative to each other. The enforcement point 402 can therefore receive the single output policy object 420 that includes the access decision rule and control rule(s) selected. Accordingly, the highest priority, matched access decision rule is considered in addition to the highest priority, matched control rule.

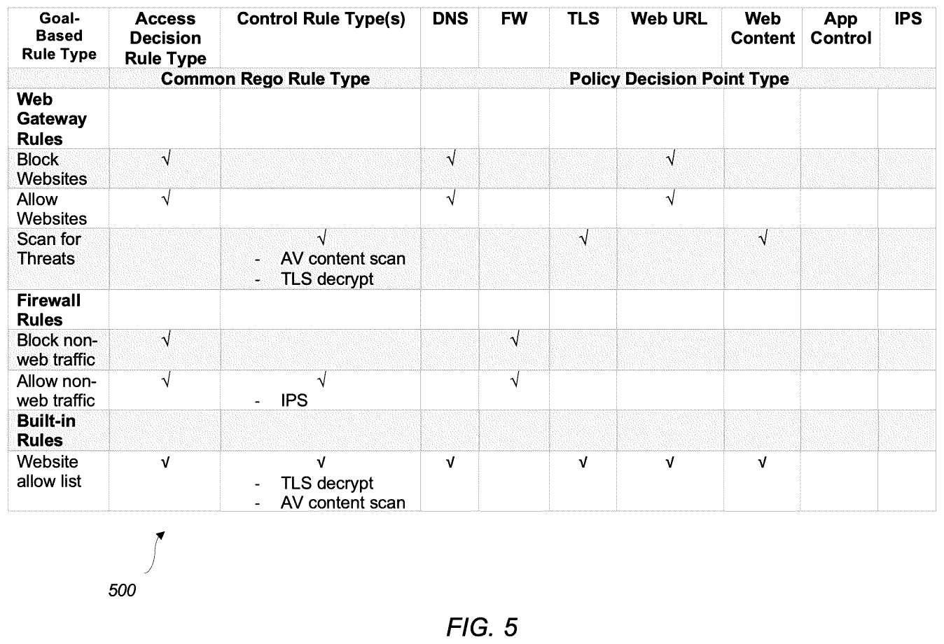

FIG. 5 depicts a table 500 showing the mapping of various goal-based rule types to common Rego rule types and the associated PDPs in accordance with one embodiment. The table 500 lists different types of goal-based rules and examples of each goal-based rule type.

The list of goal-based rules in table 500 is not exhaustive, and other types of goal-based rules in addition to or in lieu of those listed in table 500 may be considered in accordance with the described embodiments. Web gateway rules may be one type of goal-based rules, examples of which may include rules to block websites, allow websites, enforce safe search control, and scan for threats.

As discussed previously, firewall rules are another type of goal-based rule. Examples of firewall goal-based rules may include rules to block non-web traffic, allow non-web traffic, allow-decrypt-inspect traffic (not shown in FIG. 5), and block application traffic (not shown in FIG. 5).

The firewall rule to “block non-web traffic” may have match criteria such as a particular user(s) to whom the rule is applicable, the destination of an attempted connection, the applicable port and service used for the connection, or the like. The user(s) may be identified a username, group name, device name, or the like.

These goal-based rules are also assigned a common Rego type classification, referring to whether a rule is an access decision rule, a control rule, or both. The ruleset schemas may define which fields(s) are required to be populated to categorize a rule as an access decision rule or control rule. Additionally, schemas may classify a control rule as one or more specific subtypes of control rules. For example, adding an “action” field to a ruleset would imply that the rule is an access decision rule. Adding a “scanUpload” field to the ruleset would categorize the rule not only as a control rule but as a content-scan control rule.

FIG. 5 also shows the PDP types associated with each goal-based rule. As seen in FIG. 5, the “allow websites” goal-based rule allows traffic by domain at either the DNS or web filter stage. This rule is of the web gateway goal-based rule type and of the access decision type. That is, the access decision is to “allow” traffic, assuming applicable match criteria is satisfied. The associated PDP types for this rule are DNS and the Web URL.

As another example, the “scan for threats” rule is a web gateway type goal-based rule and, assuming match criteria is satisfied, scans for threats for specified user situations and destinations. This goal-based rule is a control rule, as it specifies control policy options such as to perform antivirus scanning and TLS decryption. The associated PDP types are TLS and web content.

In some embodiments, the enforcement point 402 may execute a single query regarding a policy with access decision rules and control rules. In this technique, the enforcement point requests a single policy evaluation, and the policy engine 404 would provide a single output policy object.

The OPA document 408 would contain all policy objects for the relevant type of policy, including those of both access decision rule types and control rule types. As discussed above, the control rule type of rules may be further categorized as, for example, content scan rules, website tenant control rules, decrypt rules, etc. However, these control rules are not applicable to every PDP type.

The schema for the output policy object 420 can include results of potentially multiple rule matches from different categories of rules. However, only the highest priority rule that matches is allowed per category.

For example, the output policy object 420 may include output fields from the highest ranked, matching access decision rule. The output fields of the output policy object 420 may include rule ID, as well as an action decision.

The output policy object 420 may also include identified control rules that matched. For each control rule subtype category, the output policy object 420 may include output fields from the highest priority, matched control rule that has a rank of higher-or-equal-to the priority of the highest matched access decision rule. These output fields may include the rule ID, the control rule subtype, and any associated fields associated with the control rule.

In some cases, fields contained in the access decision rule may be relevant in the matched control rule. In these cases, the fields can be repeated in a control rule object that is part of the output policy object 420. For example, a “blockPage” flag can be in a content scan control rule and in a filetypes access decision rule. The enforcement point 402 could use the control rule object, which may include data regarding the access decision rule, as part of the output policy object 420 as required for its use cases.

This approach of using a single policy query can return policy decisions and control information to the enforcement point 402 without requiring the rule rank to be exposed to the enforcement point 402. Providing the rule rank to the enforcement point 402 may require the implementation of additional policy logic.

Other embodiments may execute multiple policy queries, wherein each query matches one common Rego rule type. In these embodiments, the common Rego 418 evaluates matching rules, and selects a single highest priority rule as the output policy result for the output policy object 420. The input policy object 406 includes the policy query type. However, a default policy query may be for the policy engine 404 to find the highest ranked, matching access decision.

The enforcement point 402 may make additional queries for each type of control rule. For example, the enforcement point 402 can make a policy query for a “content scan” rule type and receive the highest matched rule from all web content rules that are control rules for the content scan query rule subtype. The enforcement point 402 may then consider the rank of the control rule relative to the rank of the access decision rule and act accordingly.

It may be possible that, if rules were considered linearly, a higher priority, matching control rule is selected over a lower priority, matching access decision rule. For example, a web content policy may contain the following two rules:
(1) Scan for threats: User A
(2) Block file types: User A, executables.

If User A attempts to download an executable file type, both of these rules would match. If these rules were evaluated linearly, rule (1) would instruct the applicable enforcement point to perform a malware scan. The file would not be blocked at this point, which would not be the correct behavior.

Instead, the embodiments herein provide a single output policy object with access components and control components of all matched rules of any access or control policy rule types. This output policy object is a JSON object of the highest-ranked, matched rules from each policy rule type, which may include multiple control subtypes. Each of these control rules may be associated with a control rule object that includes any data that is part of the policy rule and would need to be provided to an enforcement point.

The output policy object 420 may include policy decisions from the highest priority matched access decision rule, the highest priority matched control policy rule that is of equal of higher priority to the matched access decision rule. Alternatively, if none of the access or control objects match, the policy output will not include any access or control objects.

Some embodiments may transform and distribute a policy across multiple policy engines. This enables a policy engine to decide a policy earlier than would be possible if a policy engine waited until all required data is available.

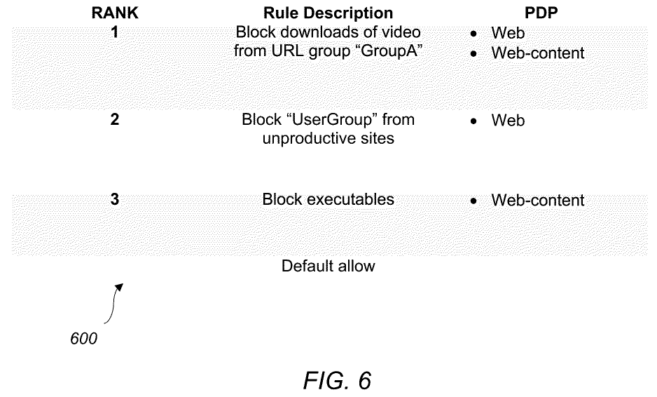

For example, a web content rule can match on different fields that may or may not be known at the same time or phase of a connection. FIG. 6 presents a table 600 listing examples of ranked rules of a policy and their associated PDPs. A web content rule may match on fields that are only known at the time of a web request, such as content type or a URL. However, another rule may match on information that isn't known until a response phase. As another example, a rule may require information provided by an AV scan, but this information isn't known until after the response content is downloaded and scanned.

As seen in FIG. 6, these rules have different priority rankings. If a high priority rule matches and would decide the correct behavior at an early stage of a connection (e.g., at HTTP request time), there would be no need to wait for response data or to later perform an AV scan. This high priority, early-matching rule could therefore make the final enforcement decision.

On the other hand, a lower priority may match a given HTTP request at an early stage of a connection. However, it may be unknown whether other higher priority rules match until a later stage of a connection, such as after a scanning. If these higher priority rules do not match, then the earlier-matched, lower priority rule would make the final enforcement decision.

Reevaluating all rules at each stage of processing could help address this problem. However, reevaluating rules at each stage of a connection is not optimal due to the required computational resources. Additionally, reevaluating all rules at each stage of a connection requires having all possible objects at each stage, and requires propagating all previously known policy input to every subsequent stage.

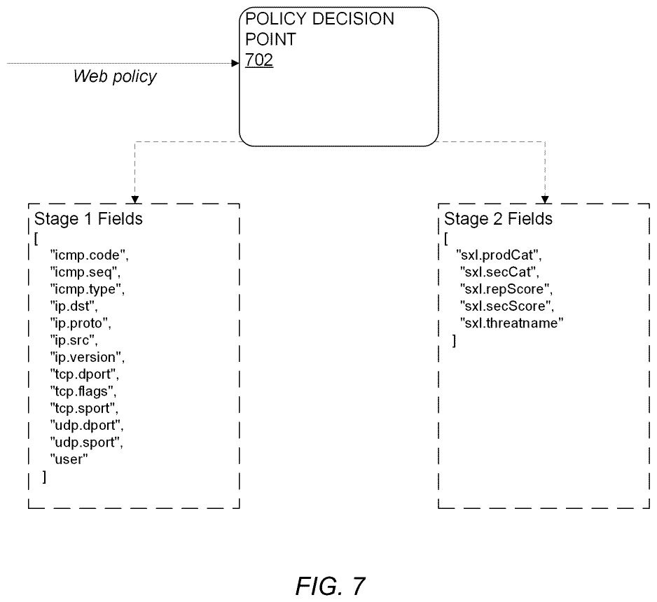

The embodiments herein may instead transform rules of a given policy into sub-rulesets to apply at each stage of a decision pipeline. FIG. 7 illustrates a PDP 702 configured to transform or otherwise split a policy into sub-policies to apply at each stage of a connection in accordance with one embodiment.

The PDP 702 may be associated with a web policy. This policy may require input such as an IP source and destination value, as well as results of a security scan. The results of a security scan may include results data referenced from the School for Extended Learning (“SXL”) data store such as a threat name (“threatname”) or security score (“secScore”).

Data regarding the IP source and destination may be available when a connection begins. At this point, it may be possible to make a policy decision just by the IP source or IP destination. If there were no other rules with a higher priority, the PDP could determine the policy at this point.

However, there may be other rules that could match in a subsequent stage. For example, a subsequent stage could look at a packet of a TLS handshake. A further subsequent stage could analyze the results of a scan. As seen in FIG. 7, attributes regarding a security scan may be determined by later accessing a storage service of data regarding threats. Accordingly, the PDP 702 may split the policy decision for the web policy into stages; Stage 1 includes the fields required for the first stage of a connection, and Stage 2 includes the fields required for the second stage of the connection, which relate to a security scan.

If the PDP 702 can completely determine the policy result at Stage 1, there will not be an evaluation at Stage 2. Additionally, each stage only needs to keep the policy objects that are relevant for that particular stage.

As another example, a sample web policy may be as follows:

```
{“ruleset”: { “rules_by_tenant”: {“44a7e33d-3084-41c0-b277-c8a3fadff223”:[
{
  “matches”:[ ],
  “result”: {
  “priority”: 1000,
  “actions”: [{“action”: “block”} ]. //RULE 1
  }
},
{
  “matches”:[
      {“op”: “eq”, “k”: [“ip”, “dst”], “v”: “172.16.0.1”},
      {“op”: “eq”, “k”: “user”, “v”: “alice@example.com”}
  ],
  “result”: {
    “priority”: 1001,
    “actions”: [{“action”: “allow”} ] //RULE 2
  }
},
{
  “matches”:[
      {“op”: “lt”, “k”: [“sxl”, “secScore”], “v”: 70},
      {“op”: “eq”, “k”: “user”, “v”: “bob@example.com”}
  ],
  “result”: {
    “priority”: 1002,
    “actions”: [{“action”: “allow”} ] //RULE 3
  }
}
]}}}
```

The above web policy includes three rules. The first rule (Rule 1) is a default block rule with a low priority (“priority”). If Rules 2 and 3 match, the rule with the higher priority field takes precedence.

The PDP 702 may execute a rule-splitting procedure to produce the following rulesets based on knowledge of the PDP types and their location in the decision pipeline:

```
Stage 1 Sub-ruleset
{ “ruleset”: { “rules_by_tenant”: { “44a7e33d-3084-41c0-b277-c8a3fadff223”: [
  {
    “matches”: [],
    “result”: {
      “priority”: 1000,
      “actions”: [ { “action”: “block”} ]
    }
  },
  {
    “matches”: [
      {“op”: “eq”, “k”: [ “ip”, “dst” ], “v”: “172.16.0.1”},
      { “op”: “eq”, “k”: “user”, “v”: “alice@example.com”}
    ],
    ″result”: {
      “priority”: 1001,
      “actions”: [ { “action”: “allow”} ]
    }
  },
  {
    “matches”: [
      { “op”: “eq”, “k”: “user”, “v”: “bob@example.com”}
    ],
    “result”: {
      “priority”: 1002,
      “actions”: [ { “action”: “partial_match”, “rule_num”: 1002 } ]
    }
  }
]}}}
Stage 2 Sub-ruleset
{ “ruleset”: { “rules_by_tenant”: { “44a7e33d-3084-41c0-b277-c8a3fadff223”: [
  {
    “matches”: [],
    “result”: {
      “priority”: 1000,
      “actions”: [ { “action”: “block”} ]
    }
  },
  {
    “matches”: [
      {“op”: “in_set″, “k”: [ “prev_matches” ], “v”: 1001 }
    ],
    “result”: {
      “priority”: 1001,
      “actions”: [ { “action”: “allow” } ]
    }
  },
  {
    “matches”: [
      { “op”: “lt”, “k”: [ “sxl”, “secScore” ], “v”: 70 },
      { “op”: “in_set”, “k”: [ “prev_matches” ], “v”: 1002 }
    ],
    “result”: {
      “priority”: 1002,
      “actions”: [ { “action”: “allow” } ]
    }
  }
]}}}
```

Each of the above sub-rulesets only match on the input fields that are specified for its stage. Although two stages are shown, there is no inherent limit on the number of stages in which a policy can be split. Also, and as seen in the Stage 1 sub-rulset, the PDP 702 has changed the result of Rule 3 from to “partial_match” and has passed along the “rule_num” field corresponding to the priority as metadata.

During evaluation of the Stage 1 rules, if Rule 3 is the highest matching rule, the PDP 702 would not be able to make a complete rule determination, and the matching should proceed to Stage 2. However, the “rule_num” of 1002 should be added as an input filed to the Stage 2 rules.

It follows that Rule 3 in Stage 2 now has a new match criteria—the input must include a “prev_matches” set that includes the value 1002. In other words, in order for Rule 3 to trigger in Stage 2, it must have matched in stage 1. This eliminates the need to pass all input fields from Stage 1 to stage 2.

If Rule 2 matches during Stage 1, it would return an “allow” result. Therefore, there would be no need to re-evaluate this connection at Stage 2, as the policy is already decided.

The above-discussed rule splitting is advantageous as it increases the speed of evaluating policies. For example, the above policy decision can occur in a matter of a few microseconds. Performing the scan and looking up the required scan-related data such as the secScore could increase decision latency by 1,000 times. Accordingly, these techniques minimize policy data requirements and the evaluation latency of PDP types by using partial results from prior policy evaluations.

Additionally, the embodiments described herein provided technical solutions for processing objects associated goal-based rules of network policies. As discussed previously in conjunction with FIG. 4, the common Rego 418 can support multiple PDP types to process a single policy query, even though the query may require multiple PDP types. This preserves computing resources, as there is no need for a policy engine to implement additional, customized software to meet the requirements of multiple PDP types.

According to one aspect, embodiments relate to a method for generating a network policy. The method includes receiving at an interface a policy including a plurality of goal-based rules to be enforced on each of a plurality of enforcement points of a network, wherein each of the plurality of enforcement points specify a match criteria to determine whether the enforcement point enforces the policy; receiving at a policy engine a rules object, wherein the rules object is associated with the policy; receiving at the policy engine a policy request from an enforcement point of the plurality of enforcement points, wherein the policy request includes a input policy object; processing, using the policy engine, the policy request by analyzing the input policy object against the rules object to determine whether the match criteria is satisfied; and providing an enforcement decision to the enforcement point regarding enforcement of the policy.

In some embodiments, each of the plurality of goal-based rules are associated with a priority ranking, and the method further includes id identifying a highest ranked goal-based rule that satisfies its specified match criteria and generating the enforcement decision based on the highest ranked policy that satisfies the match criteria.

In some embodiments, the goal-based rule is to be enforced at a second enforcement point of the plurality of enforcement points, and the method further comprises adding the match criteria specified by the second enforcement point to the rules object, wherein processing the policy request includes analyzing the input policy object against the rules object and at least one common object with the match criteria specified by the second enforcement point.

In some embodiments, the method further includes receiving at least one common object that is associated with the policy, receiving at the interface a plurality of policy objects that the match criteria may compare against, and sorting the plurality of policy objects based on which of the plurality of goal-based rules the policy objects are applicable to, wherein the rules object and the at least one common object are based on the sorted plurality of policy objects.

In some embodiments, the policy engine processes the policy request by interpreting each of the plurality of rules without implementing customized policy engine software for each of the plurality of rules.

In some embodiments, the method further includes receiving at least one common object that is associated with the policy, receiving at the policy engine an update to policy data associated with a tenant on the network, updating at least one of the common object or the rules object, and storing the updated rules object and the at least one common object for a subsequent query from the enforcement point.

In some embodiments, the method further includes defining, using the policy engine, application programming interfaces (APIs) to receive the policy request using JavaScript Object Notation (JSON) and to provide the enforcement decision to the enforcement point using JSON.

According to one aspect, embodiments relate to a system for generating a network policy. The system includes an interface for receiving a policy including a plurality of goal-based rules to be enforced on each of a plurality of enforcement points of a network, wherein each of the plurality of enforcement points specify a match criteria to determine whether the enforcement point enforces the policy; and one or more processors executing instructions stored on memory to provide a policy engine configured to receive a rules object associated with the policy; receive a policy request from an enforcement point of the plurality of enforcement points, wherein the policy request includes a input policy object; process the policy request by analyzing the input policy object against the rules object to determine whether the match criteria is satisfied; and provide an enforcement decision to the enforcement point regarding enforcement of the policy.

In some embodiments, each of the plurality of goal-based rules are associated with a priority ranking, and the policy engine is further configured to identify a highest ranked goal-based rule that satisfies its specified match criteria, and generate the enforcement decision based on the highest ranked policy that satisfies the match criteria.

In some embodiments, the goal-based rule is to be enforced at a second enforcement point of the plurality of enforcement points, and the policy engine is further configured to add the match criteria specified by the second enforcement point to the rules object and process the policy request by analyzing the input policy object against the rules object and at least one common object with the match criteria specified by the second enforcement point.

In some embodiments, the interface is further configured to receive at least one common object that is associated with the policy, receive a plurality policy objects that the match criteria may compare against, and the policy engine is further configured to sort the plurality of policy objects based on which of the plurality of goal-based rules the policy objects are applicable to, wherein the rules object and the at least one common object are based on the sorted plurality of policy objects.

In some embodiments, the policy engine processes the policy request by interpreting each of the plurality of goal-based rules without implementing customized policy engine software for each of the plurality of rules.

In some embodiments, the policy engine is further configured to receive at least one common object that is associated with the policy, receive an update to policy data associated with a tenant on the network, update at least one of the common object or the rules object, and store the updated rules object and the at least one common object for a subsequent query from the enforcement point.

In some embodiments, the policy engine is further configured to define an application programming interfaces (APIs) to receive the policy request using JavaScript Object Notation (JSON) and to provide the enforcement decision to the enforcement point using JSON.

According to yet another aspect, embodiments relate to a computer program product for generating a network policy, the computer program product comprising computer executable code embodied in one or more non-transitory computer readable media that, when executing on one or more processors, performs the steps of receiving at an interface a policy including a plurality of goal-based rules to be enforced on each of a plurality of enforcement points of a network, wherein each of the plurality of enforcement points specify a match criteria to determine whether the enforcement point enforces the policy; receiving at a policy engine a rules object, wherein the rules object is associated with the policy; receiving at the policy engine a policy request from an enforcement point of the plurality of enforcement points, wherein the policy request includes a input policy object; processing, using the policy engine, the policy request by analyzing the input policy object against the rules object to determine whether the match criteria is satisfied; and providing an enforcement decision to the enforcement point regarding enforcement of the policy.

In some embodiments, each of the plurality of goal-based rules are associated with a priority ranking, and the computer program product further comprises computer executable code that, when executing on the one or more processors, performs the step of identifying a highest ranked goal-based rule that satisfies its specified match criteria; and generating the enforcement decision based on the highest ranked policy that satisfies the match criteria.

In some embodiments, the goal-based rule is to be enforced at a second enforcement point of the plurality of enforcement points, and the computer program product further comprises computer executable code that, when executing on the one or more processors, performs the step of adding the match criteria specified by the second enforcement point to the rules object and the at least one common object, wherein processing the policy request includes analyzing the input policy object against the rules object and at least one common object with the match criteria specified by the second enforcement point.

In some embodiments, the computer program product further comprises computer-executable code that, when executing on the one or more processors, performs the steps of receiving at least one common object that is associated with the policy, receiving at the interface a plurality of policy objects that the match criteria may compare against; sorting the plurality of policy objects based on which of the plurality of goal-based rules the policy objects are applicable to, wherein the rules object and the at least one common object are based on the sorted plurality of policy objects.

In some embodiments, the policy engine processes the policy request by interpreting each of the plurality of rules without implementing customized policy engine software for each of the plurality of rules.

In some embodiments, the computer program product further comprises computer-executable code that, when executing on the one or more processors, performs the step of defining, using the policy engine, application programming interfaces (APIs) to receive the policy request using JavaScript Object Notation (JSON) and to provide the enforcement decision to the enforcement point using JSON.

According to yet another aspect, embodiments relate to method for generating a network policy. The method includes receiving at an interface a plurality of ranked goal-based rules to be enforced on at least one enforcement point of a network; determining, using a policy engine, at least one of an access component or a control component of each of the plurality of ranked goal-based rules, wherein the access component indicates whether to allow or prevent network traffic, and the control component indicates a control option regarding network traffic for the enforcement point; determining whether a match criteria associated with each of the plurality of goal-based rules is satisfied by a policy input object; generating, using the policy engine, an output policy object that includes at least one of an access component of a highest ranked goal-based rule with satisfied match criteria or a control component of a highest ranked goal-based rule with satisfied match criteria; and providing the output policy object to the enforcement point for enforcement.

In some embodiments, generating the output policy object includes determining that a goal-based rule with a control component has a lower ranking than a goal-based rule with an access component, and excluding the control component from the output policy object.

In some embodiments, the method further includes classifying each of the plurality of goal-based rules as at least one of an access rule type or a control rule type, wherein a control rule type is further classified as a particular control rule subtype specifying a control action.

In some embodiments, the output policy object further includes a control rule subtype object for enforcement by the enforcement point.

In some embodiments, generating the output policy object includes determining a plurality of access components associated with the enforcement point based on each of the plurality of goal-based rules, and determining a plurality of control components associated with the enforcement point based on each of the plurality of goal-based rules, wherein the output policy object includes the highest ranked access component and the highest ranked control component. In some embodiments, the method further includes determining that a first goal-based rule of the plurality of goal-based rules does not satisfy the match criteria, and preventing the access component or control component associated with the goal-based rule from being included in the output policy object.

In some embodiments, generating the output policy object includes defining, using the policy engine, an application programming interface (API) for categorizing the goal-based rule as an access rule, a control rule, or both, depending on the goal-based rule.

According to yet another aspect, embodiments relate to a system for generating a network policy. The system includes an interface for receiving a plurality of ranked goal-based rules to be enforced on at least one enforcement point of a network; and one or more processors executing instructions stored on memory to provide a policy engine configured to determine at least one of an access component or a control component of each of the plurality of ranked goal-based rules, wherein the access component indicates whether to allow or prevent network traffic, and the control component indicates a control option regarding network traffic for the enforcement point; determine whether a match criteria associated with each of the plurality of goal-based rules is satisfied by a policy input object; generating an output policy object that includes at least one of an access component of a highest ranked goal-based rule with satisfied match criteria or a control component of a highest ranked goal-based rule with satisfied match criteria; and provide the output policy object to the enforcement point for enforcement.

In some embodiments, the policy engine generates the output policy object by determining that a goal-based rule with a control component has a lower ranking than a goal-based rule with an access component, and excluding the control component from the output policy object.

In some embodiments, the policy engine is further configured to classify each of the plurality of goal-based rules as at least one of an access rule type or a control rule type, wherein a control rule type is further classified as a particular control rule subtype specifying a control action. In some embodiments, the output policy object further includes a control rule subtype object for enforcement by the enforcement point.

In some embodiments, the policy engine generates the output policy object by determining a plurality of access components associated with the enforcement point based on each of the plurality of goal-based rules, and determining a plurality of control components associated with the enforcement point based on each of the plurality of goal-based rules, wherein the output policy object includes the highest ranked access component and the highest ranked control component.

In some embodiments, the policy engine is further configured to determine that a first goal-based rule of the plurality of goal-based rules does not satisfy the match criteria, and prevent the access component or control component associated with the goal-based rule from being included in the output policy object.

In some embodiments, the policy engine generates the output policy object by defining an application programming interface (API) for categorizing the goal-based rule as an access rule, a control rule, or both, depending on the goal-based rule.

According to yet another aspect, embodiments relate to a computer program product for generating a network policy, the computer program product comprising computer executable code embodied in one or more non-transitory computer readable media that, when executing on one or more processors, performs the steps of receiving at an interface a plurality of ranked goal-based rules to be enforced on at least one enforcement point of a network; determining, using a policy engine, at least one of an access component or a control component of each of the plurality of ranked goal-based rules, wherein the access component indicates whether to allow or prevent network traffic and the control component indicates a control option regarding network traffic for the enforcement point; determining whether a match criteria associated with each of the plurality of goal-based rules is satisfied by a policy input object; generating, using the policy engine, an output policy object that includes at least one of an access component of a highest ranked goal-based rule with satisfied match criteria or a control component of a highest ranked goal-based rule with satisfied match criteria; and providing the output policy object to the enforcement point for enforcement.

In some embodiments, generating the output policy object includes determining that a goal-based rule with a control component has a lower ranking than a goal-based rule with an access component, and excluding the control component from the output policy object.

In some embodiments, the computer program product further includes computer-executable code that, when executing on the one or more processors, performs the step of classifying each of the plurality of goal-based rules as at least one of an access rule type or a control rule type, wherein a control rule type is further classified as a particular control rule subtype specifying a control action.

In some embodiments, generating the output policy object includes determining a plurality of access components associated with the enforcement point based on each of the plurality of goal-based rules, determining a plurality of control components associated with the enforcement point based on each of the plurality of goal-based rules, wherein the output policy object includes the highest ranked access component and the highest ranked control component.

In some embodiments, the computer program product further comprises computer-executable code that, when executing on the one or more processors, performs the steps of determining that a first goal-based rule of the plurality of goal-based rules does not satisfy the match criteria and preventing the access component or control component associated with the goal-based rule from being included in the output policy object.

In some embodiments, generating the output policy object includes defining, using the policy engine, an application programming interface (API) for categorizing the goal-based rule as an access rule, a control rule, or both, depending on the goal-based rule.

According to yet another aspect, embodiments relate to a method for generating a network policy. The method includes receiving at an interface a goal-based rule to be enforced on an enforcement point of a network; identifying, using a policy engine, a policy that associated with the enforcement point, wherein the policy specifies plurality of attributes; transforming, using the policy engine, the policy into a first sub-ruleset that receives as input a first portion of the plurality of attributes at a first stage of a connection and a second sub-ruleset that receives as input a second portion of the plurality of attributes at a second stage of the connection; and processing at least the first portion of the plurality of attributes at the first stage to determine whether to enforce the goal-based rule at the enforcement point.

In some embodiments, the first sub-ruleset includes a plurality of ranked sub-rules, and the method further includes enforcing the goal-based rule at the enforcement point without processing the second portion of the plurality of attributes based on a highest-ranked rule being satisfied by the first portion of the plurality of attributes.

In some embodiments, each of the first sub-ruleset and the second sub-ruleset include a plurality of ranked sub-rules and the method further comprises processing the second portion of the plurality of attributes at the second stage to determine whether to enforce the goal-based rule at the enforcement point, determining that a highest ranked sub-rule of the first sub-ruleset and the second sub-ruleset is satisfied by the plurality of attributes, and enforcing the goal-based rule at the enforcement point.

In some embodiments, the method further includes ensuring the second portion of the plurality of attributes do not include attributes that are not required by the second sub-ruleset.

In some embodiments, the policy associated with the enforcement point defines plurality of match criteria that must be satisfied by the plurality of attributes, wherein the method further comprises enforcing the goal-based rule with the highest priority ranking based on the plurality of match criteria being satisfied by the plurality of attributes.

In some embodiments, the method further includes modifying the second sub-ruleset based on the processing of the first portion of the plurality of attributes at the first stage. In some embodiments, the method further includes determining the second portion of the plurality of attributes satisfies the modified second-sub-ruleset, determining the first portion of the plurality of attributes satisfies the first sub-ruleset, and enforcing the goal-based rule.

According to yet another aspect, embodiments relate to a system for generating a network policy. The system includes an interface for receiving goal-based rule to be enforced on an enforcement point of a network; one or more processors executing instructions stored on memory to provide a policy engine configured to identify a policy that associated with the enforcement point, wherein the policy specifies plurality of attributes, transform the policy into a first sub-ruleset that receives as input a first portion of the plurality of attributes at a first stage of a connection and a second sub-ruleset that receives as input a second portion of the plurality of attributes at a second stage of the connection, and process at least the first portion of the plurality of attributes at the first stage to determine whether to enforce the goal-based rule at the enforcement point.

In some embodiments, the first sub-ruleset includes a plurality of ranked sub-rules, and the enforcement point is further configured to enforce the goal-based rule at the enforcement point without processing the second portion of the plurality of attributes based on a highest-ranked rule being satisfied by the first portion of the plurality of attributes.

In some embodiments, each of the first sub-ruleset and the second sub-ruleset include a plurality of ranked sub-rules and the policy engine is further configured to process the second portion of the plurality of attributes at the second stage to determine whether to enforce the goal-based rule at the enforcement point, determine that a highest ranked sub-rule of the first sub-ruleset and the second sub-ruleset is satisfied by the plurality of attributes, and enforce the goal-based rule at the enforcement point.

In some embodiments, the policy engine is further configured to ensure the second portion of the plurality of attributes do not include attributes that are not required by the second sub-ruleset.

In some embodiments, the policy associated with the enforcement point defines plurality of match criteria that must be satisfied by the plurality of attributes, wherein the enforcement point is further configured to enforce the goal-based rule with the highest priority ranking based on the plurality of match criteria being satisfied by the plurality of attributes.

In some embodiments, the policy engine is further configured to modify the second sub-ruleset based on the processing of the first portion of the plurality of attributes at the first stage. In some embodiments, the policy engine is further configured to determine the second portion of the plurality of attributes satisfies the modified second-sub-ruleset, determine the first portion of the plurality of attributes satisfies the first sub-ruleset, and enforce the goal-based rule.

According to yet another aspect, embodiments relate to a computer program product for generating a network policy, the computer program product comprising computer executable code embodied in one or more non-transitory computer readable media that, when executing on one or more processors, performs the steps of receiving at an interface a goal-based rule to be enforced on an enforcement point of a network, identifying, using a policy engine, a policy that associated with the enforcement point, wherein the policy specifies plurality of attributes, transforming, using the policy engine, the policy into a first sub-ruleset that receives as input a first portion of the plurality of attributes at a first stage of a connection and a second sub-ruleset that receives as input a second portion of the plurality of attributes at a second stage of the connection; and processing at least the first portion of the plurality of attributes at the first stage to determine whether to enforce the goal-based rule at the enforcement point.

In some embodiments, the first sub-ruleset includes a plurality of ranked sub-rules, and the computer program product further comprises computer-executable code that, when executing on the one or more processors, performs the step of enforcing the goal-based rule at the enforcement point without processing the second portion of the plurality of attributes based on a highest-ranked rule being satisfied by the first portion of the plurality of attributes.

In some embodiments, each of the first sub-ruleset and the second sub-ruleset include a plurality of ranked sub-rules, and the computer program product further comprises computer-executable code that, when executing on the one or more processors, performs the steps of processing the second portion of the plurality of attributes at the second stage to determine whether to enforce the goal-based rule at the enforcement point, determining that a highest ranked sub-rule of the first sub-ruleset and the second sub-ruleset is satisfied by the plurality of attributes, and enforcing the goal-based rule at the enforcement point.

In some embodiments, the computer program product further includes computer-executable code that, when executing on the one or more processors, performs the step of ensuring the second portion of the plurality of attributes do not include attributes that are not required by the second sub-ruleset.

In some embodiments, the policy associated with the enforcement point defines plurality of match criteria that must be satisfied by the plurality of attributes, and the computer program product further comprises computer-executable code that, when executing on the one or more processors, performs the step of enforcing the goal-based rule with the highest priority ranking based on the plurality of match criteria being satisfied by the plurality of attributes.

In some embodiments, the computer program product further includes computer-executable code that, when executing on the one or more processors, performs the step modifying the second sub-ruleset based on the processing of the first portion of the plurality of attributes at the first stage.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for generating a network policy, the method comprising:
receiving at an interface a plurality of ranked goal-based rules to be enforced on at least one enforcement point of a network;
determining, using a policy engine, at least one of an access component or a control component of each of the plurality of ranked goal-based rules, wherein:
the access component indicates whether to allow or prevent network traffic, and
the control component indicates a control option regarding network traffic for the enforcement point;
determining whether a match criteria associated with each of the plurality of goal-based rules is satisfied by a policy input object;
generating, using the policy engine, an output policy object that includes at least one of an access component of a highest ranked goal-based rule with satisfied match criteria or a control component of a highest ranked goal-based rule with satisfied match criteria; and
providing the output policy object to the enforcement point for enforcement.

2. The method of claim 1 wherein generating the output policy object includes:
determining that a goal-based rule with a control component has a lower ranking than a goal-based rule with an access component, and
excluding the control component from the output policy object.

3. The method of claim 1 further comprising classifying each of the plurality of goal-based rules as at least one of an access rule type or a control rule type, wherein a control rule type is further classified as a particular control rule subtype specifying a control action.

4. The method of claim 1 wherein the output policy object further includes a control rule subtype object for enforcement by the enforcement point.

5. The method of claim 1 wherein generating the output policy object includes:
determining a plurality of access components associated with the enforcement point based on each of the plurality of goal-based rules, and
determining a plurality of control components associated with the enforcement point based on each of the plurality of goal-based rules,
wherein the output policy object includes the highest ranked access component and the highest ranked control component.

6. The method of claim 5 further comprising:
determining that a first goal-based rule of the plurality of goal-based rules does not satisfy the match criteria, and
preventing the access component or control component associated with the goal-based rule from being included in the output policy object.

7. The method of claim 1 wherein generating the output policy object includes defining, using the policy engine, an application programming interface (API) for categorizing the goal-based rule as an access rule, a control rule, or both, depending on the goal-based rule.

8. A system for generating a network policy, the system comprising:
an interface for receiving a plurality of ranked goal-based rules to be enforced on at least one enforcement point of a network; and
one or more processors executing instructions stored on memory to provide a policy engine configured to:
determine at least one of an access component or a control component of each of the plurality of ranked goal-based rules, wherein:
the access component indicates whether to allow or prevent network traffic,
the control component indicates a control option regarding network traffic for the enforcement point;
determine whether a match criteria associated with each of the plurality of goal-based rules is satisfied by a policy input object;
generate an output policy object that includes at least one of an access component of a highest ranked goal-based rule with satisfied match criteria or a control component of a highest ranked goal-based rule with satisfied match criteria; and
provide the output policy object to the enforcement point for enforcement.

9. The system of claim 8 wherein the policy engine generates the output policy object by:
determining that a goal-based rule with a control component has a lower ranking than a goal-based rule with an access component, and
excluding the control component from the output policy object.

10. The system of claim 8 wherein the policy engine is further configured to classify each of the plurality of goal-based rules as at least one of an access rule type or a control rule type, wherein a control rule type is further classified as a particular control rule subtype specifying a control action.

11. The system of claim 10, wherein the output policy object further includes a control rule subtype object for enforcement by the enforcement point.

12. The system of claim 8 wherein the policy engine generates the output policy object by:
determining a plurality of access components associated with the enforcement point based on each of the plurality of goal-based rules, and
determining a plurality of control components associated with the enforcement point based on each of the plurality of goal-based rules,
wherein the output policy object includes the highest ranked access component and the highest ranked control component.

13. The system of claim 8 wherein the policy engine is further configured to:
determine that a first goal-based rule of the plurality of goal-based rules does not satisfy the match criteria, and
prevent the access component or control component associated with the goal-based rule from being included in the output policy object.

14. The system of claim 8 wherein the policy engine generates the output policy object by defining an application programming interface (API) for categorizing the goal-based rule as an access rule, a control rule, or both, depending on the goal-based rule.

15. A computer program product for generating a network policy, the computer program product comprising computer executable code embodied in one or more non-transitory computer readable media that, when executing on one or more processors, performs the steps of:
receiving at an interface a plurality of ranked goal-based rules to be enforced on at least one enforcement point of a network;
determining, using a policy engine, at least one of an access component or a control component of each of the plurality of ranked goal-based rules, wherein:
the access component indicates whether to allow or prevent network traffic, and
the control component indicates a control option regarding network traffic for the enforcement point;
determining whether a match criteria associated with each of the plurality of goal-based rules is satisfied by a policy input object;
generating, using the policy engine, an output policy object that includes at least one of an access component of a highest ranked goal-based rule with satisfied match criteria or a control component of a highest ranked goal-based rule with satisfied match criteria; and
providing the output policy object to the enforcement point for enforcement.

16. The computer program product of claim 15 wherein generating the output policy object includes:
determining that a goal-based rule with a control component has a lower ranking than a goal-based rule with an access component, and
excluding the control component from the output policy object.

17. The computer program product of claim 15 further comprising computer-executable code that, when executing on the one or more processors, performs the step of classifying each of the plurality of goal-based rules as at least one of an access rule type or a control rule type, wherein a control rule type is further classified as a particular control rule subtype specifying a control action.

18. The computer program product of claim 15 wherein generating the output policy object includes:
determining a plurality of access components associated with the enforcement point based on each of the plurality of goal-based rules,
determining a plurality of control components associated with the enforcement point based on each of the plurality of goal-based rules,
wherein the output policy object includes the highest ranked access component and the highest ranked control component.

19. The computer program product of claim 15 wherein the computer program product further comprises computer-executable code that, when executing on the one or more processors, performs the steps of:
determining that a first goal-based rule of the plurality of goal-based rules does not satisfy the match criteria, and
preventing the access component or control component associated with the goal-based rule from being included in the output policy object.

20. The computer program product of claim 15 wherein generating the output policy object includes defining, using the policy engine, an application programming interface (API) for categorizing the goal-based rule as an access rule, a control rule, or both, depending on the goal-based rule.
